(19) United States
(12) Patent Application Publication
(10) Pub. No.: US 2008/0135068 A1
(43) Pub. Date: Jun. 12, 2008

(54) WASHER FOR LIGHT PARTS

(75) Inventors: Robin Lee, Hamburg, NJ (US); Chris Conti, West New York, NJ (US)

Correspondence Address: Law Office of Scott C Harris, PO Box 1389, Rancho Santa Fe, CA, 92067, US

(73) Assignee: PRODUCTION RESOURCE GROUP L.L.C, New Windsor, NY (US)

(21) Appl. No.: 11/948,964

(22) Filed: Nov. 30, 2007

Related U.S. Application Data
(60) Provisional application No. 60/868,708, filed on Dec. 5, 2006.

(51) Int. Cl. B08B 3/04; B08B 3/08; B08B 3/02

(52) U.S. Cl. 134/25.5; 134/135; 134/94.1

(57) ABSTRACT

A moving light washer places moving light parts into a crate that has holes and drain parts therein, and uses the crate in a dishwasher to wash the the moving light parts. The crate can also be used for storing the lights, such that the same structure that is used for washing the lights is also used at a different time for storing the lights.

The present application claims priority from provisional application number 60/868,708, filed Dec. 5, 2006, the disclosure of which is herein incorporated by reference.

### BACKGROUND

Stage lights are often distributed to users in a rental scenario. After the users are finished using the rented lights, the lights are returned to the renter. The returned lights must be repaired and prepared for eventual reuse. Since the stage lights are often used in dirty situations, they are often returned dirty.

### SUMMARY

The present application describes a machine and technique for cleaning stage lights, and/or stage light components. According to an aspect, a “dishwasher” with an agitator is used to hold certain parts of the light. This washer is retrofit to receive a plastic crate with holes therein, and the light parts are washed within the crates within the washer.

### BRIEF DESCRIPTION OF THE DRAWINGS

In the drawings:

FIG. 1 shows a dishwasher embodiment.

### DETAILED DESCRIPTION

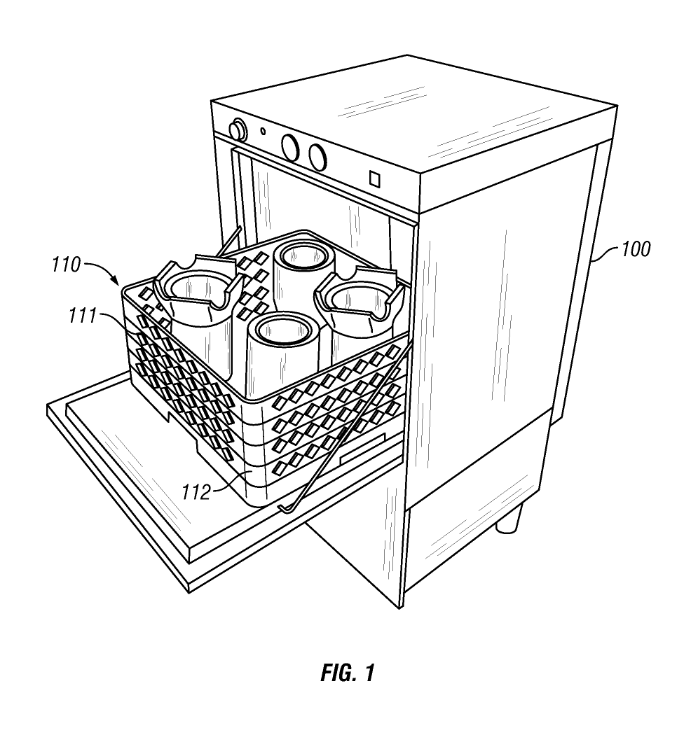

FIG. 1 shows an embodiment. A commercial dishwasher 100 includes a crate 110 which includes light parts therein. The crate can be a plastic crate, for example, formed of corrugated plastic. The plastic is formed with support pieces 111, as shown, which zigzag across the plastic, but leave openings in the plastic. Similarly, the bottom part of the crate 112 is formed with openings therein. Some parts of the crate, such as may be completely closed, but the crate must have areas to allow draining. Preferably, most parts of the crate, such as the sides and the bottom, are open. In a preferred embodiment, at least 90% of the crate's surface area includes openings. The crate is also open at the top. This facilitates cleaning.

The crates such as 110 can also be used for storage of the lights or light parts. This produces a special paradigm in which the same crates that are used for storage may also be used for washing.

The crates may also include handles, shown as 113, which allows the crates to be easily carried. The crates may be stackable for storage.

In operation, the lights or light parts may be disassembled to remove the parts that can not be wet, such as the electronics, ballasts, and the lighting parts. These parts may be removed before washing, or may be stored separately.

The remaining parts, which may include lenses and outer casings, are stored in the crate 110. The crate is placed into a dishwasher, and the parts are cleaned in that way. The dishwasher may also dry the parts using its conventional drying cycle.

Special chemicals may be used for cleaning the lights—for example, anti-spotting solution and liquid waxes.

The general structure and techniques, and more specific embodiments which can be used to effect different ways of carrying out the more general goals are described herein.

Although only a few embodiments have been disclosed in detail above, other embodiments are possible and the inventor intends these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other rotatable devices, such as color wheels, may be washed in this way. The crate has been described as being plastic; however any waterproof material could be used.

The computers described herein may be any kind of computer, either general purpose, or some specific purpose computer such as a workstation. The computer may be a Pentium class computer, running Windows XP or Linux, or may be a Macintosh computer. The programs may be written in C, or Java, or any other programming language. The programs may be resident on a storage medium, e.g., magnetic or optical, e.g. the computer hard drive, a removable disk or other removable medium. The programs may also be run over a network, for example, with a server or other machine sending signals to the local machine, which allows the local machine to carry out the operations described herein.

Also, the inventor intends that only those claims which use the words “means for” are intended to be interpreted under 35 USC 112, sixth paragraph. Moreover, no limitations from the specification are intended to be read into any claims, unless those limitations are expressly included in the claims.

What is claimed is:

1. A system for washing moving lights, comprising:
a holder formed of a waterproof material, having plural support pieces, and holding at least a plurality of moving light parts therein, said holder having at least multiple different surfaces with openings therein which allow water to pass therethrough, and said holder also including at least one water draining part therein, and a plurality of openings that allow water to pass into said crate; and
a dishwasher, holding said holder, and adapted to wash the moving light parts in said holder.

2. A system as in claim 1, wherein said holder is open over at least 90% of its surface area.

3. A system as in claim 1, wherein said holder includes handles thereon.

4. A system as in claim 1, wherein said holder is stackable with other holders.

5. A system as in claim 1, further comprising an anti-spotting solution used within the dishwasher.

6. A system as in claim 1, wherein said moving light pieces include at least lenses and outer casings of the moving light.

7. A method, comprising:
using a storage crate, having a plurality of holes therein, to store pieces of a moving light; and
using said storage crate in a dishwasher to wash said pieces of said moving light.

8 A method as in claim 7, wherein said storage crate is stackable with other storage crates to stack the moving light pieces in the crates.

9. A method as in claim 7, wherein the crate allows water to drain therefrom.

10. A method as in claim 7, further comprising using anti-spotting solution on the moving light pieces to prevent spotting.

11. A method as in claim 7, further comprising providing handles in the storage crate, and allowing the storage crate to be carried using said handles.

12. A method, comprising:
disassembling the moving light to remove parts that cannot be wet therefrom;
leaving remaining parts, that can be wet, in a crate that has a plurality of openings therein, and has at least one water draining part therein; and
using the crate in a dishwasher to wash the moving light parts.

13. A method as in claim 12, wherein said remaining parts include at least lenses and outer casings.

14. A method as in claim 12, wherein said washing comprises using an anti-spotting solution in the dishwasher.

15. A method as in claim 12, further comprising storing the moving light parts in said crate.
